(19) United States
(12) Patent Application Publication
(10) Pub. No.: US 2009/0002173 A1
(43) Pub. Date: Jan. 1, 2009

(54) METHOD, SYSTEM AND PROGRAM FOR TRACKING PHARMACEUTICAL SAMPLES

(76) Inventors: James R. Bergsten, Danville, CA (US); Jay Rosenberg, Bronx, NY (US); Thaddeus B. Kubis, Sheffield, MA (US); Jorge Noa, San Francisco, CA (US)

Correspondence Address: EDWARDS ANGELL PALMER & DODGE LLP, P.O. BOX 55874, BOSTON, MA, 02205, US

(21) Appl. No.: 12/210,841

(22) Filed: Sep. 15, 2008

Related U.S. Application Data
(63) Continuation of application No. PCT/US2007/006741, filed on Mar. 16, 2007.
(60) Provisional application No. 60/782,927, filed on Mar. 16, 2006.

(51) Int. Cl. H04B 7/00

(52) U.S. Cl. 340/572.1

(57) ABSTRACT

The invention provides a method, system and machine readable program for tracking pharmaceutical samples. A pharmaceutical sample (such as a batch of pharmaceutical products) is provided to be distributed. The pharmaceutical sample is assigned a unique radio-frequency identification tag. The pharmaceutical sample is then tracked through a chain of custody by scanning the radio-frequency identification tag at one or more points in the chain of custody. Other novel features relating to the invention are described herein.

### CROSS-REFERENCE TO RELATED APPLICATION

This application is a continuation of and claims the benefit of priority from International Patent Application No. PCT/US2007/006741, which in turn claims the benefit of priority of U.S. Provisional Patent Application Ser. No. 60/782,927 filed Mar. 16, 2006. The disclosure of each of the aforementioned patent applications is incorporated by reference herein in its entirety.

### BACKGROUND OF THE INVENTION

1. Field of the Invention

The present invention relates to a method, system and machine readable program for tracking beneficial agents, such as pharmaceutical products. Particularly, the present invention is directed to a method, system and machine readable program for tracking pharmaceutical samples.

2. Description of Related Art

Currently, it is not feasible to accurately track the dispensation and use of pharmaceutical samples. Typically, quantities of samples are provided to a team of salespersons who then distribute them to caregivers, for example, doctors, their staff, medical clinics, and hospitals. While a goal of a campaign is to entice doctors to prescribe and patients to take a company's drugs, it is difficult to determine the effectiveness of such a distribution, or campaign. For example, it is difficult to determine whether health care providers actually dispense these samples to patients.

Moreover, there are myriad compliance problems that plague the distribution of pharmaceutical samples. These problems stem in large part from a lack of information regarding the ultimate disposition of pharmaceutical samples. This lack of effective tracking data and resulting lack of compliance regularly results in substantial government fines levied against pharmaceutical companies.

Presently, the only method for tracking samples relies on manual processes. Tedious, costly, and time-consuming manual auditing may be required by factory workers, salespersons, and caregiver clerical personnel to record the receipt and disposition of samples. However, there is no way to confirm that pharmaceutical samples actually go to the appropriate parties in the correct quantities, or that their distribution actually improves pharmaceutical sales. Additionally, when this manual process is utilized, it is error prone and easy to subvert. Current systems prevent or make patient self-identification difficult as well. A patient is required to fill out and return a postage-paid reply card, or call a toll-free number.

Consequently, a method, system and machine readable program for effectively monitoring the dispensation and use of pharmaceutical samples is needed.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a method for tracking pharmaceutical samples. The method includes providing at least one pharmaceutical sample to be distributed, assigning the at least one pharmaceutical sample a unique radio-frequency identification tag, and tracking the at least one pharmaceutical sample through a chain of custody by scanning the radio-frequency identification tag at one or more points in the chain of custody.

In accordance with a further aspect of the invention, the method may further include receiving characteristics of a pharmaceutical campaign. The at least one pharmaceutical sample may then be distributed in the pharmaceutical campaign. Preferably, the at least one pharmaceutical sample includes a pharmaceutical sample batch.

In accordance with a further aspect of the invention, the method may further include determining the current status of the sample batch. The tracking step may further include collecting tracking data indicative of the at least one sample's progress through the chain of custody. The tracking data may be forwarded to a location where the tracking data may be analyzed. The tracking data may then be analyzed to facilitate evaluation of the efficacy of a pharmaceutical campaign. Moreover, if desired, the tracking data may be analyzed to facilitate compliance with compliance goals. If desired, the assigning step may include providing a range of identifiers to uniquely identify a plurality of batches of pharmaceutical samples.

In accordance with still another aspect of the invention, tracking data may be collected by scanning the radio-frequency identification tag of the sample at a plurality of points in the chain of custody. For example, the radio-frequency identification tag may be scanned at a point in the chain of custody such as one or more of a point of manufacture, a sales office, a distribution point, a caregiver location and a pharmacy. Preferably, information received from the radio-frequency identification tag is uploaded to a computer network. The computer network may include, for example, an ASP server and/or the Internet. If desired, the information may be uploaded from a mobile computing device, such as one including a RFID scanner. The information may be uploaded by way of a wireless link. Information uploaded from the radio-frequency identification tag may be directed to a database operatively associated with the computer network. The database is preferably adapted and configured to run a machine readable program adapted and configured to organize the uploaded information. The machine readable program is preferably adapted and configured to process information relating to a pharmaceutical sample campaign pertaining to the pharmaceutical sample. The machine readable program is preferably adapted and configured to process information relating to the pharmaceutical sample, the manufacturer of the sample and the structure of the campaign. In accordance with still another aspect of the invention, the machine readable program may be adapted and configured to compile a report demonstrating the efficacy of the pharmaceutical campaign. If desired, the radio-frequency identification tag may be scanned each time the tag changes custody.

In further accordance with the invention, a system for tracking pharmaceutical samples is provided. The system includes at least one pharmaceutical sample to be distributed, a first computer for assigning the at least one pharmaceutical sample a unique radio-frequency identification tag, and a tracking system for tracking the at least one pharmaceutical sample through a chain of custody. The tracking system includes at least one scanner for scanning the radio-frequency identification tag at one or more points in the chain of custody.

In accordance with further aspects of the invention, the system may be further provided with various features to facilitate implementation of aspects of the method described above, among other features such as those further embodied herein.

In still further accordance with the invention, a machine readable program on a computer readable medium containing instructions for controlling a system for tracking pharmaceutical samples is provided. The system includes a first computer code segment for assigning at least one pharmaceutical sample a unique radio-frequency identification tag and a second computer code segment to facilitate tracking the at least one pharmaceutical sample through a chain of custody. The second computer code segment is adapted and configured to receive tracking information indicative of the status of the pharmaceutical sample in the chain of custody.

In accordance with still further aspects of the invention, the machine readable program may be further provided with various features to facilitate implementation of aspects of the method described above, among other features such as those further embodied herein.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method, system and machine readable program of the invention. Together with the description, the drawings serve to explain the principles of the invention.

### BRIEF DESCRIPTION OF THE DRAWINGS

FIG. 1 is a schematic view of a system provided in accordance with the present invention.

FIG. 2 is a schematic view of a method provided in accordance with the present invention.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system and machine readable program of the invention.

The present invention is directed to a method, system and machine readable program for effectively monitoring the dispensation and use of pharmaceutical samples. In one embodiment of the invention, the monitoring system of the present invention may include a custom database, custom application software and uniquely-identifiable radio frequency identification (RFID) tags, among other things. Optional custom hardware may also be employed to allow each sample to be identified and tracked individually and/or as a member of a group.

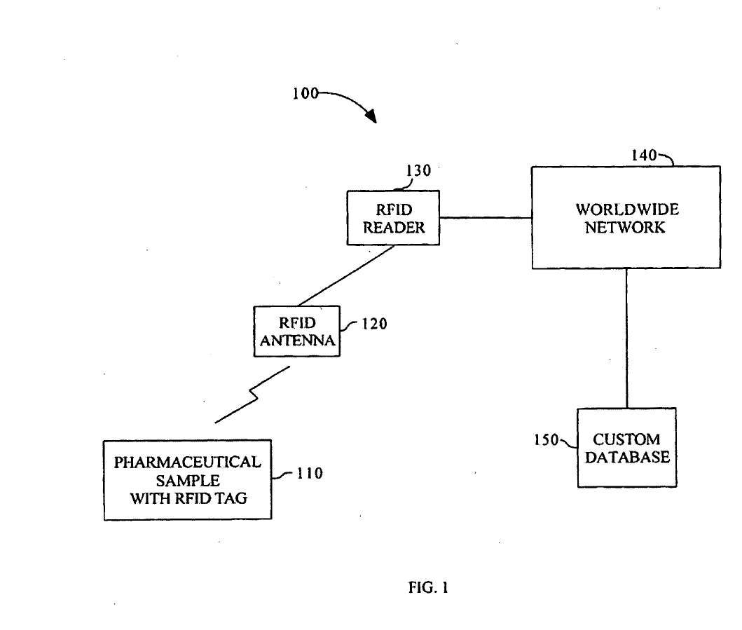

For purposes of illustration and not limitation, as embodied herein and as depicted in FIG. 1, a block diagram of a monitoring system 100 in accordance with an embodiment of the present invention is depicted. Monitoring system 100 may include a pharmaceutical sample 110 with a identification tag, such as a radio frequency identification (RFID) tag. Reference herein to a pharmaceutical “sample” is intended to refer one or more dosages of a pharmaceutical composition and associated packaging. A RFID reader 130 with a RFID antenna 120 are provided for detecting a RFID tag. The RFID tag may include unique information associated with a particular pharmaceutical sample. It is contemplated that RFID reader 130 may be capable of up-loading information retrieved from a RFID tag to a computer network 140, such as the Internet. RFID reader 130 may upload to the network 140 via a wired or wireless network link. Monitoring system 100 may also include a custom database 150 operatively associated with network 140.

Custom database 150 may include unique database tables for a particular sample campaign describing the sample, the manufacturer, the number of campaign waves, and the time and date of the campaign start and end, among other things. It is contemplated that manufacturers, doctors and others may be provided with secure access to information associated with pharmaceutical sample campaigns.

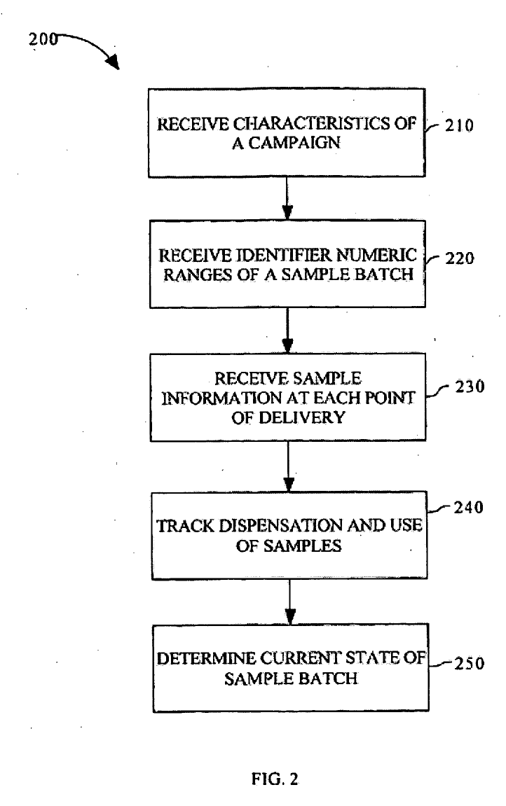

With reference to FIG. 2, a flow chart depicting a method 200 of monitoring pharmaceutical samples in accordance with an embodiment of the present invention is shown. Method 200 may begin by receiving characteristics of a campaign 210. Identifier numeric ranges of a sample batch are then provided/received 220. Pharmaceutical sample information may be retrieved at each point of delivery 230, including for example: manufacture, distribution point, doctor's office, leaving a doctor's office and at the pharmacy. Dispensation and use of samples may be tracked 240 whereby a determination of a current state of a sample batch is possible 250.

### EXAMPLE

An exemplary application of the present invention is described below. A process may include the following steps:

1. At the beginning of each pharmaceutical campaign, create/augment unique database tables for this particular sample campaign, describing the sample, the manufacturer, the number of campaign waves, and the time and date of the campaign start and end.

2. When each new batch of samples is manufactured, or when a segment of an existing campaign begins, add all sample identifier numeric ranges to the sample database, including date and time, manufacturing data, and expiration date of the sample.

3. Pharmaceutical samples bearing unique RFID tags are issued to each sales office, salesperson, and caregiver location. This ensures that samples scanned at the end locations will be the proper samples. This preferably includes scanning each sample every time the sample changes hands. For each step, the sample type, scan type, location, date, and time are collected and recorded. For each step the word scan implies scanning the location and sample RFID tags, collecting the information, and saving it into either a local database or a remote database. The local database is used in situations where the remote master database is not reachable, for example, by a salesperson in the field—in this case the scan data are uploaded to the master database after the fact. Said scanning may be performed by mobile technology, for example, a laptop or notebook computer, a personal data assistant (PDA), or a specialized device (such as a custom handheld scanner).

4. Each sample then may be scanned at one or more points in the chain of custody. For example, each sample may be scanned (1) at end of manufacture, (2) when the sample is sent from manufacturing to a field sales office, (3) when the sample is released to a salesperson at the field office, (4) when each sample is given to a health caregiver at the caregiver's location, (5) when each sample is given to a patient at the caregiver's location and/or (6) when at a pharmacy if a patient wishes to self-identify. The scanning may be performed by a pharmacy employee using new or existing point of sale technology, or by the patient using an in-store kiosk. Alternatively, a patient may use an Internet website, a toll-free number, a postage-paid reply card. Optionally, a sample package may also include information from other vendors whose products relate to the patient's condition. This invention may also be used to refer the patient to these vendors and vice versa.

5. Scan and inventory unused samples at each location to determine replenishment needs, or to identify expired, counterfeit, misplaced, or recalled goods. This scanning may be performed by visiting salespersons or by the health caregiver staff. This scan may alert the staff to supply shortages (and automatically reorder), and detect expired, counterfeit, or recalled goods.

6. Generate periodic reports for manufacturing, sales, marketing, associated complimentary vendors, and caregivers.

It is contemplated that the method and system of monitoring pharmaceutical samples provides a number of advantages. For example, all sample-related transactions, may be recorded so that a company can easily correlate caregiver prescription rates to sample distribution, thus improving the effectiveness of subsequent campaigns, and additionally to facilitate compliance with compliance goals. Some samples are provided when long-term health issues (such as diabetes) are first diagnosed. Improved tracking benefits patients, doctors, and manufacturers by allowing patients to “self identify” so that they may obtain additional knowledge about their condition, realize cost savings, and learn about other products that might improve their condition. Many samples contain prescription-only medicines and/or controlled substances—their whereabouts should be known at all times. Some samples expire, may be counterfeit, or may have to be recalled. Embodiments of the present invention address all of these issues, even allowing the source of an illicit sample to be identified. Additionally, details may be connected to each tracking event, providing in-depth marketing information that is timely, targeted and custom tailored to a company's requirements. With this information, marketing is accomplished more effectively.

Moreover, it will be appreciated by those of skill in the art that the present invention can also be used for controlling the distribution of pharmaceutical samples, and reducing the theft of such samples.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The block diagrams herein depicted in FIGS. 1-2 represent conceptual views of illustrative circuitry and software embodying the principles of the invention. Thus the functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent to those shown herein.

Similarly, it will be appreciated that the system flows in FIGS. 1-2, for example, shown herein, represent various processes which may be substantially represented in computer-readable medium and so executed by a computer or processor, whether or not such computer or processor is explicitly shown. Moreover, in the Figures shown herein, the various blocks can be understood as representing not only processing and/or other functions but, alternatively, as blocks of program code that carry out such processing or functions.

The methods and systems of the present invention, as described above and shown in the drawings, provide for a method, system, machine readable program and graphical user interface with superior functionality that can facilitate the tracking of pharmaceutical samples. It will be apparent to those skilled in the art that various modifications and variations can be made in the embodiments of the present invention without departing from the spirit or scope of the invention. Thus, it is intended that the present invention include modifications and variations that are within the scope of the appended claims and their equivalents.

What is claimed is:

1. A method for tracking pharmaceutical samples, comprising:
a) providing at least one pharmaceutical sample to be distributed;
b) assigning the at least one pharmaceutical sample a unique radio-frequency identification tag; and
c) tracking the at least one pharmaceutical sample through a chain of custody by scanning the radio-frequency identification tag at one or more points in the chain of custody.

2. The method of claim 1, further including receiving characteristics of a pharmaceutical campaign.

3. The method of claim 2, wherein the at least one pharmaceutical sample is distributed in the pharmaceutical campaign.

4. The method of claim 1, wherein the at least one pharmaceutical sample includes a pharmaceutical sample batch.

5. The method of claim 4, further comprising determining the current status of the sample batch.

6. The method of claim 1, wherein the tracking step further includes collecting tracking data indicative of the at least one sample's progress through the chain of custody.

7. The method of claim 6, further comprising forwarding the tracking data to a location where the tracking data may be analyzed.

8. The method of claim 7, further comprising analyzing the tracking data to facilitate evaluation of the efficacy of a pharmaceutical campaign.

9. The method of claim 7, further comprising analyzing the tracking data to facilitate compliance with compliance goals.

10. The method of claim 1, wherein the assigning step includes providing a range of identifiers to uniquely identify a plurality of batches of pharmaceutical samples.

11. The method of claim 1, further comprising collecting tracking data by scanning the radio-frequency identification tag at a plurality of points in the chain of custody.

12. The method of claim 11, wherein the radio-frequency identification tag is scanned at a point in the chain of custody selected from the group consisting of:
a) a point of manufacture;
b) a sales office;
c) a distribution point;
d) a caregiver location; and
e) a pharmacy.

13. The method of claim 1, further comprising uploading information received from the radio-frequency identification tag to a computer network.

14. The method of claim 13, wherein the computer network includes at least one of (i) an ASP server, and (ii) the Internet.

15. The method of claim 13, wherein the information is uploaded from a mobile computing device.

16. The method of claim 15, wherein the mobile computing device includes a RFID scanner.

17. The method of claim 15, wherein the information is uploaded by way of a wireless link.

18. The method of claim 13, further comprising directing the uploaded information to a database operatively associated with the computer network.

19. A system for tracking pharmaceutical samples, comprising:
a) at least one pharmaceutical sample to be distributed;
b) a first computer for assigning the at least one pharmaceutical sample a unique radio-frequency identification tag; and
c) a tracking system for tracking the at least one pharmaceutical sample through a chain of custody, the tracking system including at least one scanner for scanning the radio-frequency identification tag at one or more points in the chain of custody.

20. A machine readable program on a computer readable medium containing instructions for controlling a system for tracking pharmaceutical samples comprising:
a) a first computer code segment for assigning at least one pharmaceutical sample a unique radio-frequency identification tag; and
b) a second computer code segment to facilitate tracking the at least one pharmaceutical sample through a chain of custody, the second computer code segment being adapted and configured to receive tracking information indicative of the status of the pharmaceutical sample in the chain of custody.
